(19) United States
(12) Patent Application Publication
(10) Pub. No.: US 2025/0056304 A1
(43) Pub. Date: Feb. 13, 2025

(54) IMPORTANCE-BASED PROHIBITION OF UPLINK DATA TRANSMISSION

(71) Applicant: Nokia Technologies Oy, Espoo (FI)

(72) Inventors: Henri Markus KOSKINEN, Espoo (FI); Benoist Pierre SEBIRE, Tokyo (JP); Abolfazl AMIRI, Aalborg (DK)

(21) Appl. No.: 18/775,664

(22) Filed: Jul. 17, 2024

Related U.S. Application Data
(60) Provisional application No. 63/518,448, filed on Aug. 9, 2023.

(51) Int. Cl. H04W 28/02; H04W 28/08; H04W 72/1268; H04W 72/56

(52) U.S. Cl. CPC H04W 28/0268; H04W 28/0278; H04W 28/0858; H04W 72/1268; H04W 72/56

(57) ABSTRACT

A method is provided that includes receiving, at a layer of a radio protocol stack, a first uplink unit of data from a higher layer of the radio protocol stack. The first uplink unit of data is in a set of one or more first uplink units of data, and the set is marked with information including an importance value associated with the set that identifies a relative importance of the set compared to other sets within a quality of service flow. The method includes constructing a second uplink unit of data from the first uplink unit of data. And the method includes making a determination to submit the second uplink unit of data to a lower layer of the radio protocol stack, or buffer the second uplink unit of data, based on the importance value associated with the set, and a threshold importance value.

### TECHNOLOGICAL FIELD

The present disclosure relates generally to telecommunications and, in particular, to importance-based prohibition of uplink data in a telecommunications system.

### BACKGROUND

A telecommunications system can be seen as a facility that enables communication sessions between two or more entities such as user terminals, base stations and/or other nodes by providing carriers between the various entities involved in the communications path. A telecommunications system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless telecommunications system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The telecommunications system and associated devices typically operate in accordance with a given standard or specification which sets out what the various entities associated with the system are permitted to do and how that should be achieved. Communication protocols and/or parameters which shall be used for the connection are also typically defined. One example of a telecommunications system is the Universal Mobile Telecommunications System (UMTS). Other examples of telecommunications systems are Long-Term Evolution (LTE), LTE Advanced and the so-called 5G or New Radio (NR) networks. NR is being standardized by the 3rd Generation Partnership Project (3GPP).

### BRIEF SUMMARY

Example implementations of the present disclosure are directed to telecommunications and, in particular, to importance-based prohibition of uplink data in a telecommunications system. In this regard, the present disclosure includes, without limitation, the following example implementations.

Some example implementations provide an apparatus comprising: at least one memory configured to store computer-readable program code; and at least one processing circuitry configured to access the at least one memory, and execute the computer-readable program code to cause the apparatus to at least: receive, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow; construct a second uplink unit of data from the first uplink unit of data; and make a determination to submit the second uplink unit of data to a lower layer of the radio protocol stack, or buffer the second uplink unit of data, based on the importance value associated with the set, and a threshold importance value.

Some example implementations provide an apparatus comprising: means for receiving, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow; means for constructing a second uplink unit of data from the first uplink unit of data; and means for making a determination to submit the second uplink unit of data to a lower layer of the radio protocol stack, or buffer the second uplink unit of data, based on the importance value associated with the set, and a threshold importance value.

Some example implementations provide a method comprising: receiving, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow; constructing a second uplink unit of data from the first uplink unit of data; and making a determination to submit the second uplink unit of data to a lower layer of the radio protocol stack, or buffer the second uplink unit of data, based on the importance value associated with the set, and a threshold importance value.

Some example implementations provide a computer-readable storage medium that is non-transitory and has computer-readable program code stored therein that, in response to execution by at least one processing circuitry, causes an apparatus to at least: receive, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow; construct a second uplink unit of data from the first uplink unit of data; and make a determination to submit the second uplink unit of data to a lower layer of the radio protocol stack, or buffer the second uplink unit of data, based on the importance value associated with the set, and a threshold importance value.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that includes one or more public land mobile networks (PLMNs) coupled to one or more external data networks, according to some example implementations of the present disclosure;

FIG. 2 illustrates a standalone 5G deployment of a PLMN, according to some example implementations;

FIG. 3 illustrates an overview of a portion of the 5G radio protocol stack architecture, according to some example implementations;

FIG. 4 is a functional block diagram of a packet data convergence protocol (PDCP) layer of the 5G radio protocol stack, according to some example implementations;

FIG. 5 illustrates a format of a PDCP control protocol data unit (PDU), according to some example implementations;

FIGS. 6A, 6B, 6C, 6D, 6E, 6F, 6G, 6H, 6I, 6J and 6K are flowcharts that illustrate various operations in a method, according to some example implementations; and

FIG. 7 illustrates an apparatus according to some example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers including clients and servers; and within a network, these computers may be interconnected directly or indirectly by various means including via one or more switches, routers, gateways, access points or the like.

Reference may be made herein to terms specific to a particular system, architecture or the like, but it should be understood that example implementations of the present disclosure may be equally applicable to any of a number of systems, architectures and the like. For example, reference may be made to 3GPP technologies such as Global System for Mobile Communications (GSM), UMTS, LTE, LTE Advanced and 5G NR; however, it should be understood that example implementations of the present disclosure may be equally applicable to non-3GPP technologies such as IEEE 802, Bluetooth and Bluetooth Low Energy.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

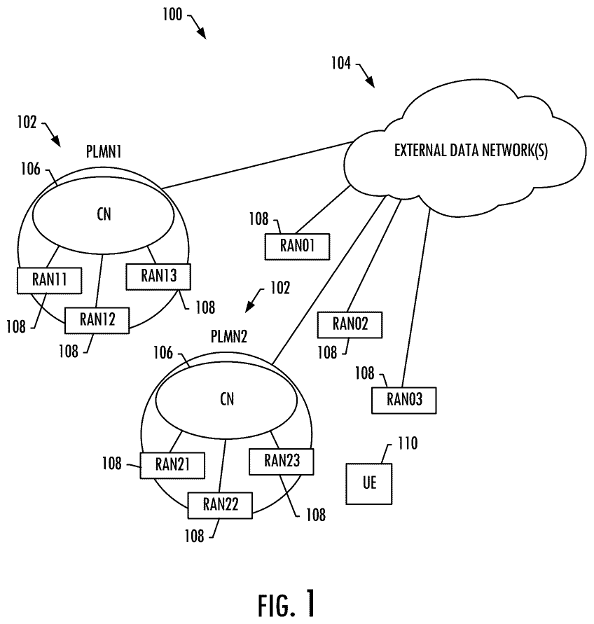

FIG. 1 illustrates a telecommunications system 100 according to various example implementations of the present disclosure. The telecommunications system generally includes one or more telecommunications networks. As shown, for example, the system includes one or more public land mobile networks (PLMNs) 102 coupled to one or more other external data networks 104—notably including a wide area network (WAN) such as the Internet. Each of the PLMNs includes a core network (CN) 106 backbone such as the Evolved Packet Core (EPC) of LTE, the 5G core network (5GC) or the like; and each of the core networks and the Internet are coupled to one or more radio access networks (RANs) 108, air interfaces or the like that implement one or more radio access technologies (RATs). As used herein, a “network device” refers to any suitable device at a network side of a telecommunications network. Examples of suitable network devices are described in greater detail below.

In addition, the system includes one or more radio units that may be varyingly known as user equipment (UE) 110, terminal device, terminal equipment, mobile station or the like. The UE is generally a device configured to communicate with a network device or a further UE in a telecommunication network. The UE may be a portable computer (e.g., laptop, notebook, tablet computer), mobile phone (e.g., cell phone, smartphone), wearable computer (e.g., smartwatch), or the like. In other examples, the UE may be an Internet of things (IoT) device, an industrial IoT (IIoT device), a vehicle equipped with a vehicle-to-everything (V2X) communication technology, or the like. Further, the various implementations of any of these devices can be used with a UE vehicle, a high altitude platform station (HAPS), or any other such type node associated with a terrestrial network or any drone type radio or a radio in aircraft or other airborne vehicles, or a vessel such as a waterborne vessel or boat.

In operation, these UEs may be configured to connect to one or more of the RANs 108 according to their particular radio access technologies to thereby access a particular core network of a PLMN 102, or to access one or more of the external data networks 104 (e.g., the Internet). The external data network may be configured to provide Internet access, operator services, 3rd party services, etc. For example, the International Telecommunication Union (ITU) has classified 5G mobile network services into three categories: enhanced mobile broadband (eMBB), ultra-reliable and low-latency communications (URLLC), and massive machine type communications (mMTC) or massive internet of things (MIoT).

Examples of radio access technologies include 3GPP radio access technologies such as GSM, UMTS, LTE, LTE Advanced, and 5G NR. Other examples of radio access technologies include IEEE 802 technologies such as IEEE 802.11 (Wi-Fi), IEEE 802.15 (including 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a radio access technology may refer to any 2G, 3G, 4G, 5G or higher generation mobile communication technology and their different versions, as well as to any other wireless radio access technology that may be arranged to interwork with such a mobile communication technology to provide access to the core network of a mobile network operator (MNO).

In various example, a RAN 108 may be configured as one or more macrocells, microcells, picocells, femtocells or the like. The RAN may generally include one or more radio access nodes that are configured to interact with UEs 110. In various examples, a radio access node may be referred to as a base station (BS), access point (AP), base transceiver station (BTS), Node B (NB), evolved NB (eNB), macro BS, NB (MNB) or eNB (MeNB), home BS, NB (HNB) or eNB (HeNB), next generation NB (gNB), next generation eNB (ng-eNB), or the like. Some type of network controlling/governing entity responsible for control of the radio access nodes. The network controlling/governing entity and radio access node may be separate or integrated into a single apparatus. The network controlling/governing entity may include processing circuitry configured to carry out various management functions, etc. The processing circuitry may be associated with a computer-readable storage medium or database for maintaining information required in the management functions.

ARAN 108 may be centralized or distributed. In various examples, components of a RAN may be interconnected by Ethernet, Gigabit Ethernet, Asynchronous Transfer Mode (ATM), optical fiber, dark fiber, passive wavelength division multiplexing (WDM), WDM passive optical network (WDM-PON), optical transport network (OTN), time sensitive networking (TSN) and/or any other data link layer network, possibly including radio links. The RAN may be connected to a CN 106 through one or more gateways, network functions or the like.

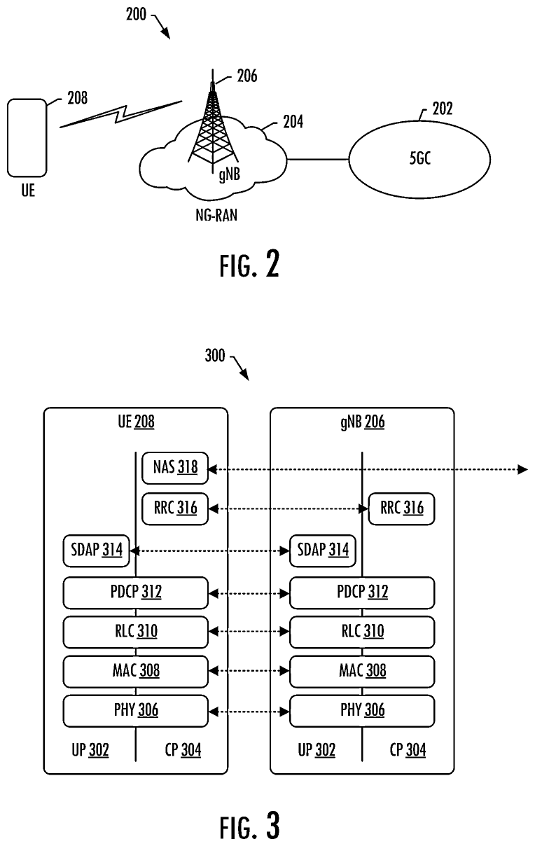

As will be appreciated, a PLMN 102 may be deployed in a number of different manners. In a 4G LTE deployment, the EPC is the CN 106, and the evolved UMTS terrestrial radio access network (E-UTRAN) is the RAN 108; and the E-UTRAN includes one or more eNBs (radio access nodes) configured connect UEs 110 to the E-UTRAN to thereby access the EPC. As shown in FIG. 2, in a 5G deployment 200, the 5GC 202 is the CN, and the next generation (NG) radio access network (NG-RAN) 204 is the RAN; and the NG-RAN includes one or more gNBs 206 (radio access nodes) configured connect UEs 208 to the NG-RAN to thereby access the 5GC. The term ‘gNB’ in 5G may correspond to the eNB in 4G LTE.

Some 4G LTE and 5G deployments are considered standalone (SA) deployments. Other deployments combine 4G LTE and 5G technologies, and are referred to as non-standalone (NSA) deployments. In some deployments, the E-UTRAN includes one or more ng-eNBs that are configured to communicate with the 5GC, and that may also be configured to communicate with one or more gNBs. Similarly, in another deployment, the NG-RAN may include one or more en-gNBs that are configured to communicate with the EPC, and that may also be configured to communicate with one or more eNBs.

FIG. 3 illustrates an overview of a portion of the 5G radio protocol stack 300 architecture, between the gNB 206 and UE 208, according to some example implementations. As shown, the 5G radio protocol stack has two different stacks depending on the type of data that is processed by the stack. User data goes through a user plane (UP) stack 302, signaling messages go through a control plane (CP) stack 304. Both UP and CP stacks are made up of a common structure including a Layer 1 (L1) with a physical layer (PHY) 306, and a layer 2 (L2) with sublayers including medium access control (MAC) 308, radio link control (RLC) 310, and packet data convergence protocol (PDCP) 312. A layer 3 (L3) sits on top of PHY/MAC/RLC/PDCP, and includes sublayers that are different between the CP and UP. In the UP, L3 includes a sublayer referred to as service data adaptation protocol (SDAP) 314 that is connected to the user plane function (UPF) in the 5GC 202. In the CP, L3 includes two sublayers referred to as radio resource control (RRC) 316 and non-access stratum (NAS) 318, and the NAS layer connects to the access and mobility function (AMF) in the 5GC.

Generally, each layer of the 5G radio protocol stack 300 performs a specific data communications task, a service to and for the layer that precedes it. For example, the RLC 310 provides its services to the PDCP 312. Similarly, the PDCP provides its services to the SDAP 314 (in the UP 302) or the RRC 316 (in the CP 304). The main services or functions of the PDCP include for example: header compression and decompression, transfer of user data, ciphering and deciphering, and timer-based SDU discard.

The process of layers of the 5G radio protocol stack 300 performing specific data communication tasks can be likened to placing a letter in a series of envelopes before it is sent through the postal system. Each succeeding envelope adds another layer of processing or overhead information necessary to process the transaction. Together, all the envelopes help make sure the letter gets to the right address and that the message received is identical to the message sent. Once the entire package is received at its destination, the envelopes are opened one by one until the letter itself emerges exactly as written.

A data flow between a source and destination, such as the UE 208 and 5GC 202, is from top to bottom in the source, across the communications line, and then from bottom to top in the destination. Each time, user data passes downward from one layer to the next layer in the source more processing information is added. When that information is removed and processed by the peer layer in the destination, it causes various tasks (error correction, flow control, etc.) to be performed.

Radio communications in deployments such as the 5G deployment 200, node operations may in be carried out, at least partly, in a central/centralized unit (CU), such as a server, host or node, operationally coupled to a distributed unit (DU), such as a radio head/node. It is also possible that node operations may be distributed among a plurality of servers, hosts or nodes. It should also be understood that the distribution of work between the 5GC 202 operations and gNB 204 operations may vary depending on implementation. Thus, a 5G network architecture may be based on a so-called CU-DU split. One gNB-CU (central node) may control one or more gNB-DUs. The gNB-CU may control a plurality of spatially separated gNB-DUs, acting at least as transmit/receive (Tx/Rx) nodes. In some example implementations, however, the gNB-DUs (also called DU) may include, for example, the RLC, MAC and PHY, whereas the gNB-CU (also called a CU) may include the layers above RLC, such as PDCP, RRC, and an internet protocol (IP) layer. Other functional splits are also possible. It is considered that skilled person is familiar with the OSI model and the functionalities within each layer.

In some example implementations, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU, and the boundary where the responsibility is shifted between the CU and the DU may be selected according to implementation.

For some time, data in PLMNs 102 has been transmitted in small units called “packets,” which serve as discrete blocks of information that carry data from one point to another. In the context of 5G and advanced networking, data is transmitted in protocol data units (PDUs). A PDU may include one or more headers and a service data unit (SDU), which is effectively the payload of the PDU. In the PDCP 312, for example, a PDU may include a PDCP header and a PDCP SDU.

Data packets such as PDUs are transferred between the UE 208 and an external data network in a communication session referred to as a PDU session, which is a communication channel established to facilitate the exchange of data. The PDU session may be anchored at the UPF in the 5GC 202. In this regard, PDU session anchor (PSA) is a term sometimes used to refer to the PDU session anchor point in the UPF.

Networks including 5G are now starting to support interactive media services such as eXtended reality (XR), which encompasses virtual reality (VR), augmented reality (AR), and mixed reality (MR). For these services, a PDU set may include one or more PDUs grouped together to carry data for one unit of information generated at the application level. In this regard, a PDU set may include PDU(s) that work together to convey a specific piece of information or a complete unit of data at the application level, such as an image, video frame, or a segment of a file. The PDU(s) of a PDU set may be transmitted within the same quality of service (QoS) flow.

Enhancements for the support of XR services include capacity enhancements using XR-awareness. This awareness may be achieved via traffic assistance information such as PDU set importance (PSI) which can be used for discarding PDU sets in case of congestion. Some discussions have focused on how and when to use PSI for uplink PDU discard and have included proposals to use the PDCP 312, and in particular, the timer-based SDU discard service of the PDCP. In this regard, the PDCP may include functional entities such as a transmitting PDCP entity and a receiving PDCP entity. The transmitting PDCP entity starts a discard timer when a PDCP SDU is received from upper layers (e.g., SDAP 314, RRC 316), and the PDCP SDU may be discarded when the discard timer expires. The duration of the discard timer may be configured by the network, typically according to a packet-delay budget or a similar delay requirement part of the radio bearer's QoS requirements, with the logic that once the discard timer expires, the PDCP SDU is considered outdated and unusable from an application-layer point of view.

In more recent discussions, there seems to be a wide assumption that upon uplink congestion detection or estimation, uplink PDUs belonging to PDU sets of some low enough importance should be discarded before the PDCP discard timer's default expiry time (reflecting a QoS delay budget), if configured and activated. But equally common seems to be the assumption that the congestion is likely to be transient. It follows that if uplink PDUs are discarded by the UE 208, in line with commands from the network, before they are actually outdated, the discarding may prove unnecessary in the end. And on returning to a congestion-free state, the UE would have had at least some non-outdated uplink PDUs for transmission if not for their being prematurely discarded.

Example implementations of the present disclosure provide a mechanism for PSI-based uplink-packet handling, which the network may command to the UE (e.g., in case of uplink congestion), that does not change the timer-based SDU discard function of the PDCP 312. As before, the transmitting PDCP entity may discard a PDCP SDU and corresponding PDU when the discard timer expires, and the duration of the discard timer may only be changed via an RRC reconfiguration.

Instead, according to some example implementations, the mechanism for PSI-based uplink-packet handling may prohibit or restrict uplink transmission (more precisely, submission from the PDCP 312 to the underlying RLC 310) of uplink PDUs based on their associated PSI values, whenever the network activates the mechanism. In some examples, the uplink PDUs that are stored at the UE 208 but whose transmission is prohibited may also be excluded from an uplink-buffer status that the UE reports to the network, such as in a MAC buffer status report (BSR).

Since the timer-based SDU discard function of the PDCP 312 may not be changed, an uplink packet that is rendered outdated in the UE 208 buffer may still be discarded by the discard timer. When the network lifts the transmission restriction (e.g., when the congestion is alleviated or the gNB 206 estimates the congestion is alleviated), then, packets to which the restriction previously applied may still be transmitted, provided that their discard timer (if configured) has not yet expired. Uplink packets may therefore not be prematurely discarded, but only when actually outdated. Meanwhile, uplink congestion may still be alleviated by the UE holding back less important data for as long as commanded by the network—while after such a time, transmission of that data is still possible.

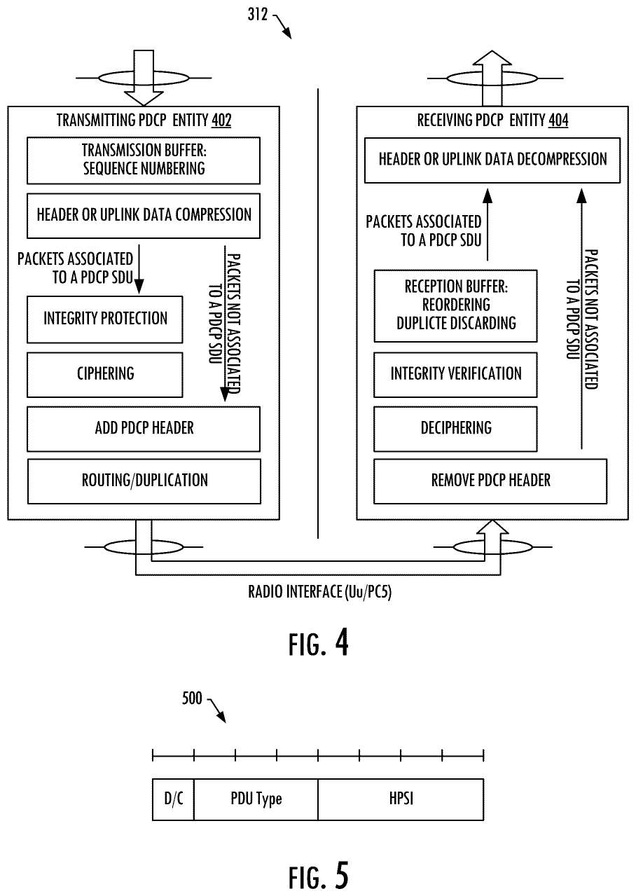

Example implementations of the present disclosure may be implemented at a layer of a radio protocol stack, and in particular by a transmitting entity of the layer. Example implementations are described below in the context of the PDCP 312; and in this regard, FIG. 4 is a functional block diagram of an example implementation of the PDCP, including a transmitting PDCP entity 402 and a receiving PDCP entity 404. On the uplink, the transmitting PDCP entity may be implemented at the UE 208, and the receiving PDCP entity may be implemented at the gNB 206 (or a second UE); and on the downlink, the transmitting PDCP entity may be implemented at the gNB (or second UE), and the receiving PDCP entity may be implemented at the UE. In some example implementations, the mechanism for PSI-based uplink-packet handling may be implemented by the transmitting PDCP entity.

According to some example implementations, the transmitting PDCP entity 402 of the PDCP 312 (at the UE 208) may be configured to receive a first uplink unit of data from a higher layer (e.g., SDAP 314, RRC 316), the first uplink unit of data in these examples being an uplink PDCP SDU. The uplink PDCP SDU may be in a set of one or more uplink PDCP SDUs, at times referred to as a PDU set. In this regard, the uplink PDCP SDU may be marked with information including an importance value associated with the PDU set that identifies a relative importance of the PDU set compared to other PSU sets within a QoS flow. In some particular examples, the importance value is a PSI value associated with the PDU set.

The transmitting PDCP entity 402 may be configured to construct a second uplink unit of data from the uplink PDCP SDU, namely for example, an uplink PDCP data PDU (or at times more simply an uplink PDCP PDU). The transmitting PDCP entity may be configured to make a determination to submit the uplink PDCP PDU to a lower layer (e.g., RLC 310) of the radio protocol stack, or buffer the PDCP PDU, based on the PSI value associated with the PDU set, and a threshold PSI value (e.g., MAX PSI) that may be as more specifically described below. This may be without any change to the discard timer of the transmitting PDCP entity. Instead, in some examples, the threshold PSI value may be provided in control data from the network, such as in case of uplink congestion. The transmitting entity may receive the control data including the threshold PSI value as a PDCP control PDU, which may also direct the transmitting PDCP entity to implement PSI-based uplink-packet handling based on the threshold PSI value.

In some examples, then, the transmitting PDCP entity 402 may be configured to receive a PDCP control PDU or other control data on the downlink that includes the threshold PSI value. The determination to submit or buffer the uplink PDCP PDU may then be made based on the threshold PSI value, as included in the control data. Similarly, when the PDCP control PDU is received, the transmitting PDCP entity may make the determination for any, already buffered (stored) uplink PDCP PDUs not submitted to the lower layer, based on PSI values associated with PDU set(s) that include the bufffered second units of data, and the threshold PSI value.

FIG. 5 illustrates a format of a PDCP control PDU 500, according to some example implementations. As shown, the PDCP control PDU may include a D/C field that indicates whether the PDCP control PDU is a data PDU or control PDU (in this case, a control PDU). The PDCP control PDU may incude a PDU type field that indciates the type of control information included in the PDCP control PDU, which in this case may indicate PSI-based uplink-packet handling (e.g., PSI prohibition). And the PDCP control PDU may include a threshold PSI field that indicates the threshold PSI, which may be referred to as a highest PSI (HPSI) field in examples (described below) in which the threshold PSI is a highest PSI.

In some examples, the threshold PSI value identifies a lowest relative importance that units of data submitted to the lower layer are allowed to be associated with. In some of these examples, the threshold PSI value is in a range of PSI values (e.g., 0 to 15) that increase with a corresponding decrease in relative importance, and the threshold PSI value is a highest PSI value that units of data submitted to the lower layer are allowed to be associated with. In particular, for example, the range of PSI values may extend from a value of 0 that indicates the highest relative importance, up to a value of 15 that indicates the lowest relative importance. The PSI value associated with the PDU set, then, may satisfy the threshold PSI value when the PSI value is not greater than, or not greater than or equal to, the threshold value. Conversely, the PSI value may not satisfy the threshold PSI value when the PSI value is greater than (or greater than or equal to) the threshold value.

In examples in which the PSI value associated with the PDU set satisfies the threshold PSI value, the determination may be made to submit the uplink PDCP PDU, and the transmitting PDCP entity 402 may submit the uplink PDCP PDU to the lower layer of the radio protocol stack. In other examples in which the PSI value associated with the PDU set does not satisfy the threshold PSI value, the determination may be made to buffer the uplink PDCP PDU, and the transmitting PDCP entity may store the uplink PDCP PDU in a transmission buffer.

In some examples, the transmitting PDCP entity 402 is further configured to start a discard timer when the uplink PDCP SDU is received. The transmitting PDCP entity may then discard, from the transmission buffer, the uplink PDCP PDU not submitted to the lower layer, when the discard timer expires. But in other examples, such as when the congestion is alleviated or estimated to be alleviated, the transmitting PDCP entity may receive a PDCP control PDU or other control data on the downlink that includes an updated threshold PSI value, before the discard timer expires. The transmitting PDCP entity may make the determination to submit the uplink PDCP PDU based on the PSI value satisfying the updated threshold PSI value (e.g., the PSI value associated with the PDU set not greater than (or not greater than or equal to) the updated threshold PSI value). The transmitting PDCP entity may then submit the uplink PDCP PDU (from the transmission buffer) to the lower layer of the radio protocol stack.

In some examples, the PSI-based uplink-packet handling may include a transmit-prohibit timer that indicates a duration that some PDCP PDUs are prohibited from being submitted to the lower layer. The duration of the transmit-prohibit timer may be shorter than the duration of the discard timer, although alternatively, the duration of the transmit-prohibit timer may be longer. In some examples, the duration of the transmit-prohibit timer may depend on the PSI value of the uplink PDCP SDU. In some of these examples, the duration of the transmit-prohibit timer may be configured by an upper control plane layer (e.g., RRC 316). Likewise, in some of these examples, the duration of the transmit-prohibit timer may be provided in control data from the network, such as in a PDCP control PDU, which may be the same as or different from the PDCP control PDU that includes the threshold PSI value.

In some examples including the transmit-prohibit timer, the threshold PSI value may identify a highest relative importance of units of data for which the transmit-prohibit timer is used. In some of these examples, and in which (as before) the threshold PSI value is in a range of PSI values that increase with a corresponding decrease in relative importance, the threshold PSI value may be a lowest PSI value of units of data for which the transmit-prohibit timer is used. The PSI value associated with the PDU set may then satisfy the threshold PSI value when the PSI value is greater than, or greater than or equal to, the threshold value. Conversely, the PSI value may not satisfy the threshold PSI value when the PSI value is not greater than (or not greater than or equal to) the threshold value.

In some examples, then, the transmitting PDCP entity 402 is configured to start a transmit-prohibit timer when the uplink PDCP SDU is received. In some of these examples, when the PSI value associated with the PDU set does not satisfy the threshold PSI value, the PDCP transmitting entity may make the determination to buffer the uplink PDCP PDU until the transmit-prohibit timer expires. In this regard, the transmitting PDCP entity may store the uplink PDCP PDU in the transmission buffer, and then submit the uplink PDCP PDU (from the transmission buffer) to the lower layer of the radio protocol stack, when the transmit-prohibit timer expires.

Similar to before, the transmitting PDCP entity 402 may still start a discard timer when the uplink PDCP SDU is received, and discard (from the transmission buffer) the uplink PDCP PDU not submitted to the lower layer, when the discard timer expires before or after the transmit-prohibit timer expires. But in other examples, such as when the congestion is alleviated or estimated to be alleviated, the transmitting PDCP entity may receive control data (e.g., PDCP control PDU) that includes an updated threshold PSI value or an updated duration of the transmit-prohibit timer, before the discard timer expires. The transmitting PDCP entity may make the determination to submit the uplink PDCP PDU based on the PSI value satisfying the updated threshold PSI value, or based on the updated duration (and thereby the transmit-prohibit timer) expiring. The transmitting PDCP entity may then submit the uplink PDCP PDU (from the transmission buffer) to the lower layer of the radio protocol stack.

In various examples in which the PSI value associated with the PDU set does not satisfy the threshold PSI value, and the determination is to buffer the uplink PDCP PDU, the uplink PDCP PDU may also be excluded from an uplink buffer status that the UE 208 reports to the network, such as in a MAC buffer status report (BSR). In this regard, the transmitting PDCP entity 402 may trigger the MAC 308 of the UE 208 to transmit a BSR that includes information on an amount of data available for transmission, with the amount of data excluding the uplink PDCP PDU. Additionally or alternatively, the transmitting PDCP entity may transmit a preemptive BSR, such as a MAC preemptive BSR, that includes information on an amount of data available for transmission, where the amount of data includes the uplink PDCP PDU. The preemptive BSR including the uplink PDCP PDU may be particualrly useful in examples including the transmit-prohibit timer, where the duration of the transmit-prohibit timer is less than the duration of the discard timer.

In some examples, the UE 208 may be configured with a trigger to transmit the BSR when, following activation of PSI-based uplink-packet handling, the amount of uplink data available for transmission decreases, or decreases enough to warrant sending a new BSR.

In some examples in which the UE 208 is configured to transmit a BSR, the UE may have an extra uplink allocation, such as due to the design of the BSR tables that round up a requested grant size to the next data point in the BSR tables, or simply an over-allocation by the gNB 206. In some of these examples, the UE may fill the extra uplink allocation with the PDCP PDU (and any other similar PDCP PDUs) of PDU sets not satisfying the threshold PSI value.

In a more particular example, the UE may calculate a buffer status for those PDCP PDUs that satisfy the threshold PSI value; and assuming the buffer size=X bytes, the UE may report the next closest value to X in a chosen BSR table, which may be Y≥X or Y=X+a (with a≥0). The gNB may receive the BSR and, depending on scheduling conditions, allocate Z bytes to the UE. In some scenarios, Z may be greater than or equal to Y, Z≥Y (Z=Y+b (with b≥0)), which may be due to reasons such as physical resource blocks (PRB) restrictions, and that the allocation cannot be a fraction of a PRB. The UE may fill up the grant with X bytes, presuming no new PDCP PDUs from PDU sets satisfying the threshold PSI value have entered the buffers since the BSR reporting instance. In this scenario, the UE may end up with an extra grant of E=Z−X=X+a+b−X=a+b bytes. And the UE may fill the rest of the grant (E bytes) from those PDCP PDU(s) of PDU sets not satisfying the threshold PSI value, instead of padding.

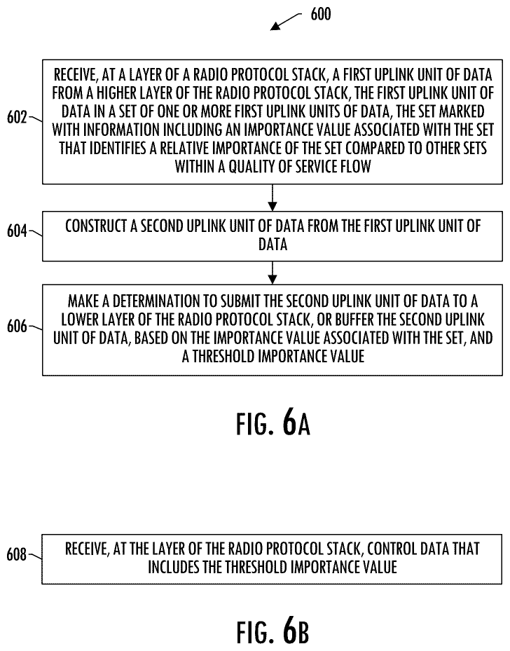

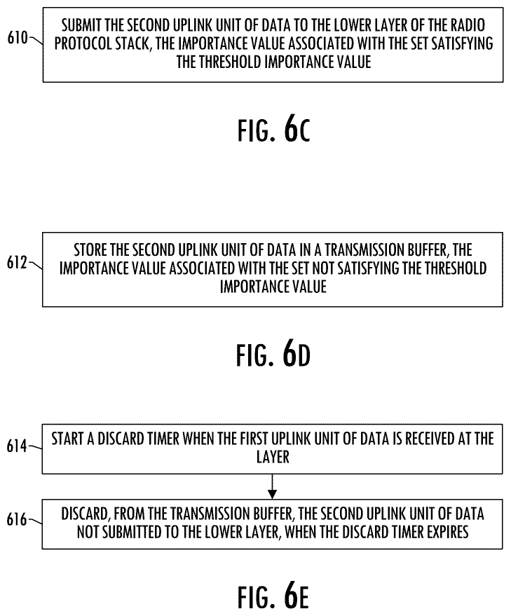

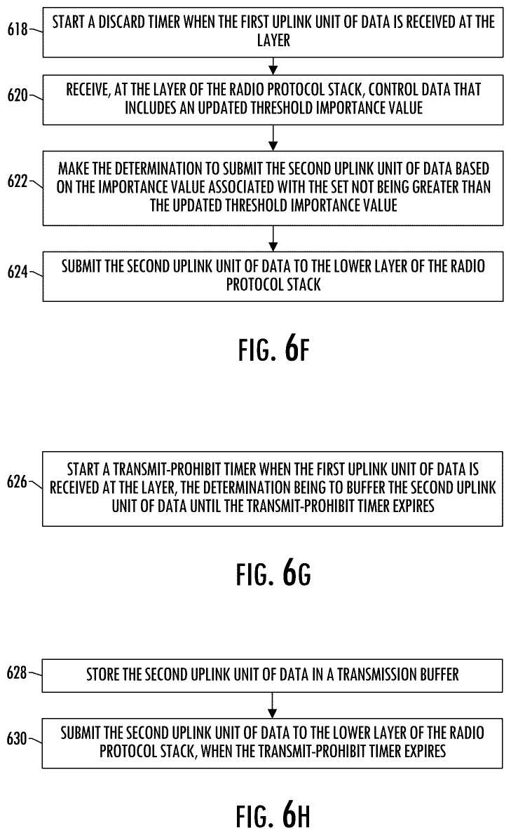

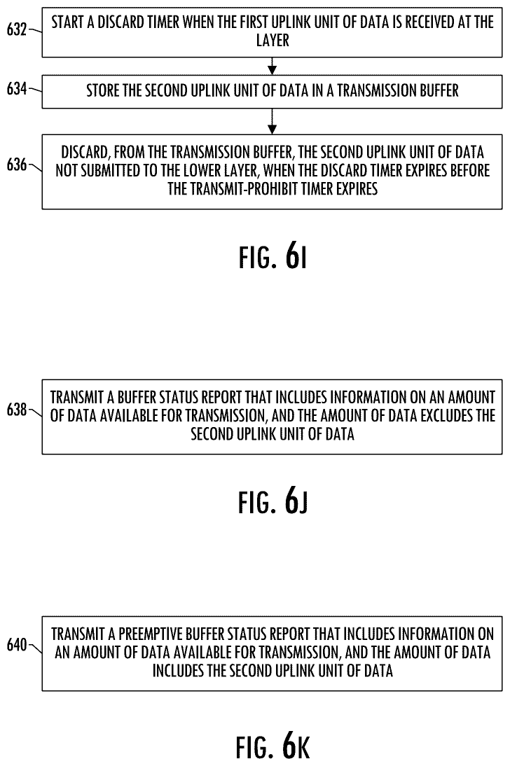

FIGS. 6A-6K are flowcharts illustrating various steps in a method 600 according to various example implementations. The method includes receiving, at a layer of a radio protocol stack, a first uplink unit of data from a higher layer of the radio protocol stack, as shown at block 602 of FIG. 6A. The first uplink unit of data is in a set of one or more first units of data, and the first uplink unit of data marked with information including an importance value associated with the set that identifies a relative importance of the set compared to other sets within a quality of service flow. The method includes constructing a second uplink unit of data from the first uplink unit of data, as shown at block 604. And the method includes making a determination to submit the second uplink unit of data to a lower layer of the radio protocol stack, or buffer the second uplink unit of data, based on the importance value associated with the set, and a threshold importance value, as shown at block 606.

In some examples, the method 600 further includes receiving, at the layer of the radio protocol stack, control data that includes the threshold importance value, as shown at block 608 of FIG. 6B. In some of these examples, the determination to submit or buffer the second uplink unit of data is made at block 606 based on the threshold importance value, as included in the control data.

In some examples, the method 600 further includes making the determination for any bufffered second units of data not submitted to the lower layer, based on importance values associated with one or more sets that include the bufffered second units of data, and the threshold importance value, when the control data is received.

In some examples in which, the importance value associated with the set satisfies the threshold importance value, and the determination is to submit the second uplink unit of data. In some of these examples, the method further includes submitting the second uplink unit of data to the lower layer of the radio protocol stack, as shown at block 610 of FIG. 6C.

In some examples, the importance value associated with the set does not satisfy the threshold importance value, and the determination is to buffer the second uplink unit of data. In some of these examples, the method further includes storing the second uplink unit of data in a transmission buffer, as shown at block 612 of FIG. 6D.

In some examples further, the method 600 further includes starting a discard timer when the first uplink unit of data is received at the layer, as shown at block 614 of FIG. 6E. In some of these examples, the method includes, after the second uplink unit of data is stored, discarding, from the transmission buffer, the second uplink unit of data not submitted to the lower layer, when the discard timer expires, as shown at block 616.

In some examples, the method 600 further includes starting a discard timer when the first uplink unit of data is received at the layer, as shown at block 618 of FIG. 6F. In some of these examples, after the second uplink unit of data is stored but before the discard timer expires, the method includes receiving, at the layer of the radio protocol stack, control data that includes an updated threshold importance value, as shown at block 620. The method includes making the determination to submit the second uplink unit of data based on the importance value associated with the set not being greater than, or not being greater than or equal to, the updated threshold importance value, as shown at block 622. And the method includes submitting the second uplink unit of data to the lower layer of the radio protocol stack, as shown at block 624.

In some examples, the importance value associated with the set does not satisfy the threshold importance value. In some of these examples, the method 600 further includes starting a transmit-prohibit timer when the first uplink unit of data is received at the layer, and the determination is to buffer the second uplink unit of data until the transmit-prohibit timer expires, as shown at block 626 of FIG. 6G.

In some examples, the method 600 further includes storing the second uplink unit of data in a transmission buffer, as shown at block 628 of FIG. 6H. And in some of these examples, the method includes submitting the second uplink unit of data to the lower layer of the radio protocol stack, when the transmit-prohibit timer expires, as shown at block 630.

In some examples, the method 600 further includes starting a discard timer when the first uplink unit of data is received at the layer, as shown at block 632 of FIG. 6I. In some of these examples, the method includes storing the second uplink unit of data in a transmission buffer, as shown at block 634. And the method includes discarding, from the transmission buffer, the second uplink unit of data not submitted to the lower layer, when the discard timer expires before the transmit-prohibit timer expires, as shown at block 636.

In some examples, the importance value associated with the set does not satisfy the threshold importance value, and the determination is to buffer the second uplink unit of data. In some of these examples, the method 600 further includes transmitting a buffer status report that includes information on an amount of data available for transmission, and the amount of data excludes the second uplink unit of data, as shown at block 638 of FIG. 6J.

In some examples, the importance value associated with the set does not satisfy the threshold importance value, and the determination is to buffer the second uplink unit of data. In some of these examples, the method 600 further includes transmitting a preemptive buffer status report that includes information on an amount of data available for transmission, and the amount of data includes the second uplink unit of data, as shown at block 640 of FIG. 6K.

According to example implementations of the present disclosure, a telecommunications system 100 or PLMN 102, and its components such as a gNB 206 and/or UE 208, may be implemented by various means. Means for implementing the system and its components may include hardware, alone or under direction of one or more computer programs from a computer-readable storage medium, such as computer memory (or more simply “memory”). In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

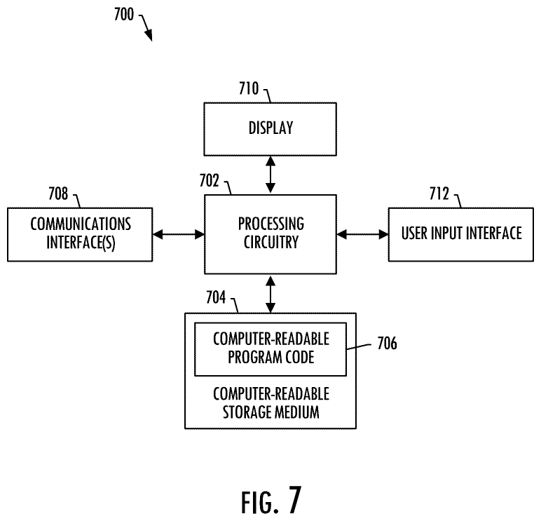

FIG. 7 illustrates an apparatus 700 according to some example implementations of the present disclosure. Generally, an apparatus of exemplary implementations of the present disclosure may comprise, include or be embodied in one or more fixed or portable electronic devices. Examples of suitable electronic devices include a wearable computer, mobile phone, portable computer, desktop computer, workstation computer, server (server computer) or the like. The apparatus may include one or more of each of a number of components such as, for example, processing circuitry 702 connected to computer-readable storage medium 704.

The processing circuitry 702 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the computer-readable storage medium 704 (of the same or another apparatus).

The processing circuitry 702 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise include one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The computer-readable storage medium 704 is generally any piece of computer hardware that is capable of storing information such as, for example, data, computer programs (e.g., computer-readable program code 706) and/or other suitable information either on a temporary basis and/or a permanent basis. The computer-readable storage medium may include volatile and/or non-volatile memory, and may be fixed or removable. Examples of suitable memory include random access memory (RAM), read-only memory (ROM), a hard drive, a flash memory, a thumb drive, a removable computer diskette, an optical disk or some combination of the above. The computer-readable storage medium is a non-transitory device capable of storing information, and is distinguishable from computer-readable transmission media such as electronic transitory signals capable of carrying information from one location to another. The term “non-transitory,” as used herein, is a limitation of the medium itself (i.e., tangible, not a signal) as opposed to a limitation on data storage persistency (e.g., RAM versus ROM). Computer-readable medium as described herein may generally refer to a computer-readable storage medium or computer-readable transmission medium.

In addition to the computer-readable storage medium 704, the processing circuitry 702 may also be connected to one or more interfaces for displaying, transmitting and/or receiving information. The interfaces may include a communications interface 708 and/or one or more user interfaces. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 710 and/or one or more user input interfaces 712. The display may be configured to present or otherwise display information to a user, suitable examples of which include a liquid crystal display (LCD), light-emitting diode (LED) display, organic LED (OLED) display, active-matrix OLED (AMOLED) or the like. The user input interfaces may be wired or wireless, and may be configured to receive information from a user into the apparatus, such as for processing, storage and/or display. Suitable examples of user input interfaces include a microphone, image or video capture device, keyboard or keypad, joystick, touch-sensitive surface (separate from or integrated into a touchscreen), biometric sensor or the like. The user interfaces may further include one or more interfaces for communicating with peripherals such as printers, scanners or the like.

As indicated above, program code instructions may be stored in a computer-readable storage medium, and executed by processing circuitry that is thereby programmed, to implement functions of the systems, subsystems, tools and their respective elements described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processing circuitry or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

Execution of instructions by a processing circuitry, or storage of instructions in a computer-readable storage medium, supports combinations of operations for performing the specified functions. In this manner, an apparatus 700 may include a processing circuitry 702 and a computer-readable storage medium 704 coupled to the processing circuitry, where the processing circuitry is configured to execute computer-readable program code 706 stored in the computer-readable storage medium. It will also be understood that one or more functions, and combinations of functions, may be implemented by special purpose hardware-based computer systems and/or processing circuitry which perform the specified functions, or combinations of special purpose hardware and program code instructions.

As explained above and reiterated below, the present disclosure includes, without limitation, the following example implementations.

Clause 1. An apparatus comprising: at least one memory configured to store computer-readable program code; and at least one processing circuitry configured to access the at least one memory, and execute the computer-readable program code to cause the apparatus to at least: receive, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow; construct a second uplink unit of data from the first uplink unit of data; and make a determination to submit the second uplink unit of data to a lower layer of the radio protocol stack, or buffer the second uplink unit of data, based on the importance value associated with the set, and a threshold importance value.

Clause 2. The apparatus of clause 1, wherein the at least one processing circuitry is configured to execute the computer-readable program code to cause the apparatus to further at least: receive, at the layer of the radio protocol stack, control data that includes the threshold importance value, and wherein the determination to submit or buffer the second uplink unit of data is made based on the threshold importance value, as included in the control data.

Clause 3. The apparatus of clause 1 or clause 2, wherein when the importance value associated with the set does not satisfy the threshold importance value, the determination is to buffer the second uplink unit of data, and the at least one processing circuitry is configured to execute the computer-readable program code to cause the apparatus to further at least: store the second uplink unit of data in a transmission buffer.

Clause 4. The apparatus of clause 3, wherein the at least one processing circuitry is configured to execute the computer-readable program code to cause the apparatus to further at least: start a discard timer when the first uplink unit of data is received at the layer; and after the second uplink unit of data is stored, discard, from the transmission buffer, the second uplink unit of data not submitted to the lower layer, when the discard timer expires.

Clause 5. The apparatus of clause 3 or clause 4, wherein the at least one processing circuitry is configured to execute the computer-readable program code to cause the apparatus to further at least: start a discard timer when the first uplink unit of data is received at the layer; and after the second uplink unit of data is stored but before the discard timer expires, receive, at the layer of the radio protocol stack, control data that includes an updated threshold importance value; make the determination to submit the second uplink unit of data based on the importance value associated with the set not being greater than, or not being greater than or equal to, the updated threshold importance value; and submit the second uplink unit of data to the lower layer of the radio protocol stack.

Clause 6. The apparatus of any of clauses 1 to 5, wherein the importance value associated with the set does not satisfy the threshold importance value, and wherein the at least one processing circuitry is configured to execute the computer-readable program code to cause the apparatus to further start a transmit-prohibit timer when the first uplink unit of data is received at the layer, and the determination is to buffer the second uplink unit of data until the transmit-prohibit timer expires.

Clause 7. The apparatus of any of clauses 1 to 6, wherein when the importance value associated with the set does not satisfy the threshold importance value, the determination is to buffer the second uplink unit of data, and the at least one processing circuitry is configured to execute the computer-readable program code to cause the apparatus to further at least: transmit a buffer status report that includes information on an amount of data available for transmission, and the amount of data excludes the second uplink unit of data.

Clause 8. An apparatus comprising: means for receiving, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow; means for constructing a second uplink unit of data from the first uplink unit of data; and means for making a determination to submit the second uplink unit of data to a lower layer of the radio protocol stack, or buffer the second uplink unit of data, based on the importance value associated with the set, and a threshold importance value.

Clause 9. The apparatus of clause 8, wherein the apparatus further comprises: means for receiving, at the layer of the radio protocol stack, control data that includes the threshold importance value, and wherein the determination to submit or buffer the second uplink unit of data is made based on the threshold importance value, as included in the control data.

Clause 10. The apparatus of clause 8 or clause 9, wherein when the importance value associated with the set does not satisfy the threshold importance value, the determination is to buffer the second uplink unit of data, and the apparatus further comprises: means for storing the second uplink unit of data in a transmission buffer.

Clause 11. The apparatus of clause 10, wherein the apparatus further comprises: means for starting a discard timer when the first uplink unit of data is received at the layer; and after the second uplink unit of data is stored, means for discarding, from the transmission buffer, the second uplink unit of data not submitted to the lower layer, when the discard timer expires.

Clause 12. The apparatus of clause 10 or clause 11, wherein the apparatus further comprises: means for starting a discard timer when the first uplink unit of data is received at the layer; and after the second uplink unit of data is stored but before the discard timer expires, means for receiving, at the layer of the radio protocol stack, control data that includes an updated threshold importance value; means for making the determination to submit the second uplink unit of data based on the importance value associated with the set not being greater than, or not being greater than or equal to, the updated threshold importance value; and means for submitting the second uplink unit of data to the lower layer of the radio protocol stack.

Clause 13. The apparatus of any of clauses 8 to 12, wherein the importance value associated with the set does not satisfy the threshold importance value, and wherein the apparatus further comprises means for starting a transmit-prohibit timer when the first uplink unit of data is received at the layer, and the determination is to buffer the second uplink unit of data until the transmit-prohibit timer expires.

Clause 14. The apparatus of any of clauses 8 to 13, wherein when the importance value associated with the set does not satisfy the threshold importance value, the determination is to buffer the second uplink unit of data, and the apparatus further comprises: means for transmitting a buffer status report that includes information on an amount of data available for transmission, and the amount of data excludes the second uplink unit of data.

Clause 15, A method comprising: receiving, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow; constructing a second uplink unit of data from the first uplink unit of data; and making a determination to submit the second uplink unit of data to a lower layer of the radio protocol stack, or buffer the second uplink unit of data, based on the importance value associated with the set, and a threshold importance value.

Clause 16. The method of clause 15, wherein the method further comprises: receiving, at the layer of the radio protocol stack, control data that includes the threshold importance value, and wherein the determination to submit or buffer the second uplink unit of data is made based on the threshold importance value, as included in the control data.

Clause 17. The method of clause 15 or clause 16, wherein when the importance value associated with the set does not satisfy the threshold importance value, the determination is to buffer the second uplink unit of data, and the method further comprises: storing the second uplink unit of data in a transmission buffer.

Clause 18. The method of clause 17, wherein the method further comprises: starting a discard timer when the first uplink unit of data is received at the layer; and after the second uplink unit of data is stored, discarding, from the transmission buffer, the second uplink unit of data not submitted to the lower layer, when the discard timer expires.

Clause 19. The method of clause 17 or clause 18, wherein the method further comprises: starting a discard timer when the first uplink unit of data is received at the layer; and after the second uplink unit of data is stored but before the discard timer expires, receiving, at the layer of the radio protocol stack, control data that includes an updated threshold importance value; making the determination to submit the second uplink unit of data based on the importance value associated with the set not being greater than, or not being greater than or equal to, the updated threshold importance value; and submitting the second uplink unit of data to the lower layer of the radio protocol stack.

Clause 20. The method of any of clauses 15 to 19, wherein the importance value associated with the set does not satisfy the threshold importance value, and wherein the method further comprises starting a transmit-prohibit timer when the first uplink unit of data is received at the layer, and the determination is to buffer the second uplink unit of data until the transmit-prohibit timer expires.

Clause 21. The method of any of clauses 15 to 20, wherein when the importance value associated with the set does not satisfy the threshold importance value, the determination is to buffer the second uplink unit of data, and the method further comprises: transmitting a buffer status report that includes information on an amount of data available for transmission, and the amount of data excludes the second uplink unit of data.

Clause 22. A computer-readable storage medium that is non-transitory and has computer-readable program code stored therein that, in response to execution by at least one processing circuitry, causes an apparatus to at least: receive, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow; construct a second uplink unit of data from the first uplink unit of; and make a determination to submit the second uplink unit of data to a lower layer of the radio protocol stack, or buffer the second uplink unit of data, based on the importance value associated with the set, and a threshold importance value.

Clause 23. The computer-readable storage medium of clause 22, wherein the computer-readable storage medium has further computer-readable program code stored therein that, in response to execution by the at least one processing circuitry, causes the apparatus to further at least: receive, at the layer of the radio protocol stack, control data that includes the threshold importance value, and wherein the determination to submit or buffer the second uplink unit of data is made based on the threshold importance value, as included in the control data.

Clause 24. The computer-readable storage medium of clause 22 or clause 23, wherein when the importance value associated with the set does not satisfy the threshold importance value, the determination is to buffer the second uplink unit of data, and the computer-readable storage medium has further computer-readable program code stored therein that, in response to execution by the at least one processing circuitry, causes the apparatus to further at least: store the second uplink unit of data in a transmission buffer.

Clause 25. The computer-readable storage medium of clause 24, wherein the computer-readable storage medium has further computer-readable program code stored therein that, in response to execution by the at least one processing circuitry, causes the apparatus to further at least: start a discard timer when the first uplink unit of data is received at the layer; and after the second uplink unit of data is stored, discard, from the transmission buffer, the second uplink unit of data not submitted to the lower layer, when the discard timer expires.

Clause 26. The computer-readable storage medium of clause 24 or clause 25, wherein the computer-readable storage medium has further computer-readable program code stored therein that, in response to execution by the at least one processing circuitry, causes the apparatus to further at least: start a discard timer when the first uplink unit of data is received at the layer; and after the second uplink unit of data is stored but before the discard timer expires, receive, at the layer of the radio protocol stack, control data that includes an updated threshold importance value: make the determination to submit the second uplink unit of data based on the importance value associated with the set not being greater than, or not being greater than or equal to, the updated threshold importance value; and submit the second uplink unit of data to the lower layer of the radio protocol stack.

Clause 27. The computer-readable storage medium of any of clauses 22 to 26, wherein the importance value associated with the set does not satisfy the threshold importance value, and wherein the computer-readable storage medium has further computer-readable program code stored therein that, in response to execution by the at least one processing circuitry, causes the apparatus to further start a transmit-prohibit timer when the first uplink unit of data is received at the layer, and the determination is to buffer the second uplink unit of data until the transmit-prohibit timer expires.

Clause 28. The computer-readable storage medium of any of clauses 22 to 27, wherein when the importance value associated with the set does not satisfy the threshold importance value, the determination is to buffer the second uplink unit of data, and the computer-readable storage medium has further computer-readable program code stored therein that, in response to execution by the at least one processing circuitry, causes the apparatus to further at least: transmit a buffer status report that includes information on an amount of data available for transmission, and the amount of data excludes the second uplink unit of data.

Clause 29. An apparatus comprising means for performing the method of any of clauses 15 to 21.

Clause 30. A computer-readable medium comprising computer-readable program code that, in response to execution by at least one processing circuitry, causes an apparatus to perform the method of any of clauses 15 to 21.

Clause 31. A computer-readable storage medium comprising computer-readable program code that, in response to execution by at least one processing circuitry, causes an apparatus to perform the method of any of clauses 15 to 21.

Clause 32. A computer program comprising computer-readable program code that, in response to execution by at least one processing circuitry, causes an apparatus to perform the method of any of clauses 15 to 21.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims, Although specific terms are employed herein, they are used in a generic and descriptive sense only and not for purposes of limitation.

What is claimed is:

1. An apparatus comprising:
at least one memory configured to store computer-readable program code; and
at least one processing circuitry configured to access the at least one memory, and execute the computer-readable program code to cause the apparatus to at least:
receive, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow;
construct a second uplink unit of data from the first uplink unit of data; and
make a determination to submit the second uplink unit of data to a lower layer of the radio protocol stack, or buffer the second uplink unit of data, based on the importance value associated with the set, and a threshold importance value.

2. The apparatus of claim 1, wherein the at least one processing circuitry is configured to execute the computer-readable program code to cause the apparatus to further at least:
receive, at the layer of the radio protocol stack, control data that includes the threshold importance value, and
wherein the determination to submit or buffer the second uplink unit of data is made based on the threshold importance value, as included in the control data.

3. The apparatus of claim 1, wherein when the importance value associated with the set does not satisfy the threshold importance value, the determination is to buffer the second uplink unit of data, and the at least one processing circuitry is configured to execute the computer-readable program code to cause the apparatus to further at least:
store the second uplink unit of data in a transmission buffer.

4. The apparatus of claim 3, wherein the at least one processing circuitry is configured to execute the computer-readable program code to cause the apparatus to further at least:
start a discard timer when the first uplink unit of data is received at the layer; and
after the second uplink unit of data is stored,
discard, from the transmission buffer, the second uplink unit of data not submitted to the lower layer, when the discard timer expires.

5. The apparatus of claim 3, wherein the at least one processing circuitry is configured to execute the computer-readable program code to cause the apparatus to further at least:
start a discard timer when the first uplink unit of data is received at the layer; and after the second uplink unit of data is stored but before the discard timer expires,
receive, at the layer of the radio protocol stack, control data that includes an updated threshold importance value;
make the determination to submit the second uplink unit of data based on the importance value associated with the set not being greater than, or not being greater than or equal to, the updated threshold importance value; and
submit the second uplink unit of data to the lower layer of the radio protocol stack.

6. The apparatus of claim 1, wherein the importance value associated with the set does not satisfy the threshold importance value, and
wherein the at least one processing circuitry is configured to execute the computer-readable program code to cause the apparatus to further start a transmit-prohibit timer when the first uplink unit of data is received at the layer, and the determination is to buffer the second uplink unit of data until the transmit-prohibit timer expires.

7. The apparatus of claim 1, wherein when the importance value associated with the set does not satisfy the threshold importance value, the determination is to buffer the second uplink unit of data, and the at least one processing circuitry is configured to execute the computer-readable program code to cause the apparatus to further at least:
transmit a buffer status report that includes information on an amount of data available for transmission, and the amount of data excludes the second uplink unit of data.

8. A method comprising:
receiving, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow;
constructing a second uplink unit of data from the first uplink unit of data; and
making a determination to submit the second uplink unit of data to a lower layer of the radio protocol stack, or buffer the second uplink unit of data, based on the importance value associated with the set, and a threshold importance value.

9. The method of claim 8, wherein the method further comprises:
receiving, at the layer of the radio protocol stack, control data that includes the threshold importance value, and
wherein the determination to submit or buffer the second uplink unit of data is made based on the threshold importance value, as included in the control data.

10. The method of claim 8, wherein when the importance value associated with the set does not satisfy the threshold importance value, the determination is to buffer the second uplink unit of data, and the method further comprises:
storing the second uplink unit of data in a transmission buffer.

11. The method of claim 10, wherein the method further comprises:
starting a discard timer when the first uplink unit of data is received at the layer; and after the second uplink unit of data is stored,
discarding, from the transmission buffer, the second uplink unit of data not submitted to the lower layer, when the discard timer expires.

12. The method of claim 10, wherein the method further comprises:
starting a discard timer when the first uplink unit of data is received at the layer; and after the second uplink unit of data is stored but before the discard timer expires,
receiving, at the layer of the radio protocol stack, control data that includes an updated threshold importance value;
making the determination to submit the second uplink unit of data based on the importance value associated with the set not being greater than, or not being greater than or equal to, the updated threshold importance value; and
submitting the second uplink unit of data to the lower layer of the radio protocol stack.

13. The method of claim 8, wherein the importance value associated with the set does not satisfy the threshold importance value, and
wherein the method further comprises starting a transmit-prohibit timer when the first uplink unit of data is received at the layer, and the determination is to buffer the second uplink unit of data until the transmit-prohibit timer expires.

14. The method of claim 8, wherein when the importance value associated with the set does not satisfy the threshold importance value, the determination is to buffer the second uplink unit of data, and the method further comprises:
transmitting a buffer status report that includes information on an amount of data available for transmission, and the amount of data excludes the second uplink unit of data.

15. A computer-readable storage medium that is non-transitory and has computer-readable program code stored therein that, in response to execution by at least one processing circuitry, causes an apparatus to at least:
receive, at a layer of a radio protocol stack, a first uplink unit of data from a higher layer of the radio protocol stack, the first uplink unit of data in a set of one or more first uplink units of data, the set marked with information including an importance value associated with the set that identifies a relative importance of the set compared to other sets within a quality of service flow;
construct a second uplink unit of data from the first uplink unit of data; and
make a determination to submit the second uplink unit of data to a lower layer of the radio protocol stack, or buffer the second uplink unit of data, based on the importance value associated with the set, and a threshold importance value.

16. The computer-readable storage medium of claim 15, wherein the computer-readable storage medium has further computer-readable program code stored therein that, in response to execution by the at least one processing circuitry, causes the apparatus to further at least:
receive, at the layer of the radio protocol stack, control data that includes the threshold importance value, and
wherein the determination to submit or buffer the second uplink unit of data is made based on the threshold importance value, as included in the control data.

17. The computer-readable storage medium of claim 15, wherein when the importance value associated with the set does not satisfy the threshold importance value, the determination is to buffer the second uplink unit of data, and the computer-readable storage medium has further computer-readable program code stored therein that, in response to execution by the at least one processing circuitry, causes the apparatus to further at least:
store the second uplink unit of data in a transmission buffer.

18. The computer-readable storage medium of claim 17, wherein the computer-readable storage medium has further computer-readable program code stored therein that, in response to execution by the at least one processing circuitry, causes the apparatus to further at least:
start a discard timer when the first uplink unit of data is received at the layer; and after the second uplink unit of data is stored,
discard, from the transmission buffer, the second uplink unit of data not submitted to the lower layer, when the discard timer expires.

19. The computer-readable storage medium of claim 17, wherein the computer-readable storage medium has further computer-readable program code stored therein that, in response to execution by the at least one processing circuitry, causes the apparatus to further at least:
start a discard timer when the first uplink unit of data is received at the layer; and after the second uplink unit of data is stored but before the discard timer expires,
receive, at the layer of the radio protocol stack, control data that includes an updated threshold importance value;
make the determination to submit the second uplink unit of data based on the importance value associated with the set not being greater than, or not being greater than or equal to, the updated threshold importance value; and
submit the second uplink unit of data to the lower layer of the radio protocol stack.

20. The computer-readable storage medium of claim 15, wherein the importance value associated with the set does not satisfy the threshold importance value, and
wherein the computer-readable storage medium has further computer-readable program code stored therein that, in response to execution by the at least one processing circuitry, causes the apparatus to further start a transmit-prohibit timer when the first uplink unit of data is received at the layer, and the determination is to buffer the second uplink unit of data until the transmit-prohibit timer expires.

21. The computer-readable storage medium of claim 15, wherein when the importance value associated with the set does not satisfy the threshold importance value, the determination is to buffer the second uplink unit of data, and the computer-readable storage medium has further computer-readable program code stored therein that, in response to execution by the at least one processing circuitry, causes the apparatus to further at least:
transmit a buffer status report that includes information on an amount of data available for transmission, and the amount of data excludes the second uplink unit of data.
